(19) United States
(12) Patent Application Publication
(10) Pub. No.: US 2025/0097523 A1
(43) Pub. Date: Mar. 20, 2025

(54) CUSTOMIZED AUDIO FILTERING OF CONTENT

(71) Applicant: ROKU, INC., San Jose, CA (US)

(72) Inventors: Neena Mohanachandran SAILAJA, Cambridge (GB); Trent PARKER, San Jose, CA (US)

(73) Assignee: ROKU, INC., San Jose, CA (US)

(21) Appl. No.: 18/468,386

(22) Filed: Sep. 15, 2023

(51) Int. Cl. H04N 21/439

(52) U.S. Cl. CPC H04N 21/4396; H04N 21/4394

(57) ABSTRACT

Disclosed herein are system, apparatus, article of manufacture, method and/or computer program product embodiments, and/or combinations and sub-combinations thereof, for automatically filtering out audio in an audio track of a content. An example embodiment operates by receiving a filtering instruction for a media device, identifying a filtering content in an audio track of a content to be presented on the media device based on the filtering instruction, filtering out the filtering content in the audio track of the content, and presenting the filtered content on the media device.

### BACKGROUND

### Field

This disclosure is generally directed to customized audio filtering of a content to be presented on a media device, and more particularly to automatically filtering out selected audio in an audio track of the content to be presented by a media device based on filtering instructions and content filtering rules.

### Summary

Provided herein are system, apparatus, article of manufacture, method and/or computer program product embodiments, and/or combinations and sub-combinations thereof, for automatically filtering out selected audio in an audio track of a content to be presented by a media device. In some embodiments, a filtering instruction can be received from a user for a media device. In some embodiments, the filtering instruction can include a text input from the user. A content filtering system can identify the filtering content in the captioning data of the content based on a search of the text input. The content filtering system can further identify the filtering content in the audio track of the content based on timestamp correspondence between the captioning data and the audio track.

In some embodiments, the filtering instruction can include a voice input. In some embodiments, the content filtering system can use a machine-learning model to determine an audio fingerprint of the voice input and identify the filtering content in the audio track of content based on the audio fingerprint. The content filtering system can further identify the filtering content in the captioning data of the content based on timestamp correspondence between the captioning data and the audio track. In some embodiments, the content filtering system can determine a text corresponding to the voice input and identify the filtering content in the captioning data of the content based on the determined text. The content filtering system can further identify the filtering content in the audio track of the content based on timestamp correspondence between the captioning data and the audio track.

In some embodiments, the filtering instruction can include a selection of a filtering content from a predefined list of filtering contents. In some embodiments, the predefined list can include a text of the filtering content. The content filtering system can identify the filtering content in the captioning data and the audio track of the content based on timestamp correspondence between the captioning data and the audio track. In some embodiments, the predefined list can include an audio fingerprint of the filtering content. The content filtering system can identify the filtering content in the audio track of the content based on the audio fingerprint. In some embodiments, the predefined list includes an audio of the filtering content. The content filtering system can identify the filtering content in the audio track of the content based on determined audio fingerprint for the audio or timestamp correspondence between the captioning data and the audio track of the filtering content.

In some embodiments, the filtering content can be filtered out of the audio track of the content and the filtered content can be presented on the media device to the user. In some embodiments, the filtering content can be bleep out or muted in the audio track of the content. In some embodiments, the filtering content in the captioning data of content can be replaced with asterisks.

An example embodiment of a system can include a storage module and at least one processor each coupled to the storage module and configured to perform various operations to automatically filtering out audio in an audio track of a content to be presented on a media device. In an example, the at least one processor can be configured to receive a filtering instruction for a content to be presented by a media device. Afterwards, the at least one processor can be configured to identify a filtering content in an audio track of the content based on the filtering instruction. In addition, the at least one processor can be configured to filter out the filtering content in the audio track of the content. The at least one processor can be further configured to present the filtered content on the media device.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of a content server having corresponding captioning data and audio for each frame of a content, according to some embodiments.

FIG. 4 illustrates a block diagram of a system for customized audio filtering of a content to be presented on a media device, according to some embodiments.

FIG. 5 is a flowchart illustrating a method for identifying a filtering content in an audio track of a content based on a text input, according to some embodiments.

FIG. 6 is a flowchart illustrating a method for identifying a filtering content in captioning data and an audio track of a content based on an audio fingerprint of a voice input, according to some embodiments.

FIG. 7 is a flowchart illustrating a method for identifying a filtering content in captioning data and an audio track of a content according to a determined text of a voice input, according to some embodiments.

FIG. 8 is a flowchart illustrating a method for automatically filtering out a filtering content in an audio track of a content to be presented on a media device based on a filtering instruction, according to some embodiments.

FIG. 9 is a flowchart illustrating a method for automatically filtering out a filtering content in an audio track of a content to be presented on a media device based on an identified audience, according to some embodiments.

FIG. 10 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As technology advances for multimedia and communication, many types of media content are readily available for streaming and/or display. For example, media content can be delivered via various communication technologies so that the media content can be easily accessed, watched, or listened to anywhere and anytime by both children and adults. Compared to the early days when media content may be limited to printed publications or delivered by radio, current media content can be available in various forms such as videos, movies, advertisement, audio files, text, etc., and any combination thereof. In general, media content may be referred to as content, which may include one or more content items, where one content item can include a plurality of scenes and each scene can include a sequence of frames. Each frame can have associated captioning data and audio tracks corresponding to each other based on a timestamp of the frame. How to efficiently and accurately deliver appropriate content to viewers, users, or audiences, can be of value to those parties as well as the content creators. Viewers, audiences, and users (and similar parties and entities) are used interchangeably in the current description.

Television (TV) offers viewers access to content via subscription to cable or satellite services or through over-the-air broadcasts. In general, content, such as multimedia content, can be delivered from a content source device operated by a content provider to millions of viewers. Different viewers can have different sensitivity level of the words in a content based on their culture, faith, beliefs, community, country, etc. At the same time, globalization of the media industry can give viewers around the world access to a wider range of international media content. However, viewers may not be able to filter out unpleasant words or audios when watching a media content, such as a movie or a video.

Additionally, some words in international media content can be considered normal and usual by viewers in one culture, but they can be considered offensive and unpleasant by viewers in another culture. Similar issues exist with closed captioning data of media content. The corresponding translation of one or more words appropriate in a media content in one language may not be appropriate for a viewer in another language. For example, the word “asambandham” may be normal in a Malayalam movie and the word is acceptable in the local culture. However, the word “asambandham” may be translated into “bullsh*t” in English in the closed captioning data, which can have a stronger sensation than the context in which the word is originally used. The viewer of a translated Malayalam Movie may not be able to filter “asambandham” from the audio track or “bullsh*t” from the closed captioning data.

Moreover, some words may be appropriate for adults but may be inappropriate for children. When children and their parents watch movies together, these inappropriate words in the audio track and the captioning data of a media content may not be filtered out for the kids. Though some media contents may have certain inappropriate words filtered out when received, such as bleeped out or muted in the audio track and replaced with asterisks in the captioning data, the viewers may not be able to customize the inappropriate words in the filtered media contents.

Provided herein are system, apparatus, device, method and/or computer program product embodiments, and/or combinations and sub-combinations thereof, for automatically filtering out customized text and audio in the captioning data and audio track of a content to be presented on a media device. In some embodiments, a media device can receive a filtering instruction from a user for the media device. In some embodiments, the filtering instruction can include a selection of a filtering content in a predefined list of filtering contents. The filtering content can include a text or an audio of a word, a phrase, or a sentence. In some embodiments, the filtering instruction can include a text input or a voice input from the user. The filtering content can be determined based on the text input and/or the voice input. The filtering content can be identified and matched by a machine-learning model in the content to be presented on the media device and can be filtered out in captioning data and an audio track of the content. With customization of the filtering content, the filtered content presented to the user can be personalized, which can improve the user's experience of watching the filtered content. In some embodiments, parents can set up inappropriate words for the kids. When an audience, such as a child, is detected within a vicinity of a media device, a filtering content can be determined for the audience based on content filtering rules. The determined filtering content can be filtered out in the captioning data and audio track of the content.

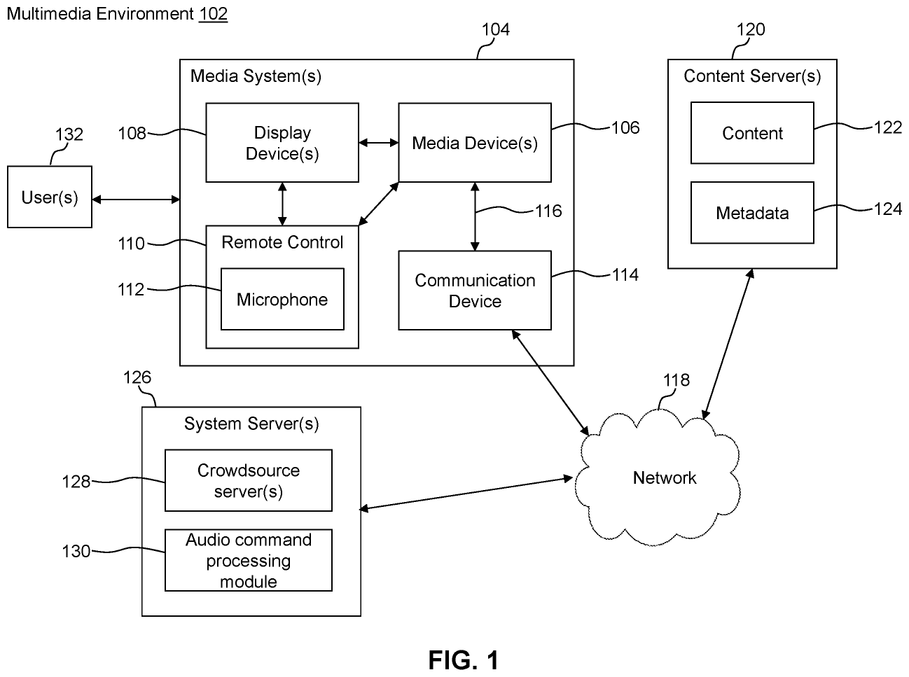

Various embodiments of this disclosure may be implemented using and/or may be part of a multimedia environment 102 shown in FIG. 1. It is noted, however, that multimedia environment 102 is provided solely for illustrative purposes and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102 including a content filtering system for automatically filtering out text and audio in the captioning data and audio track of a content presented on a media device based on filtering instructions and content filtering rules, according to some embodiments. Multimedia environment 102 illustrates an example environment, architecture, ecosystem, etc., in which various embodiments of this disclosure may be implemented. However, multimedia environment 102 is provided solely for illustrative purposes, and is not limiting. Embodiments of this disclosure may be implemented and/or used in environments different from and/or in addition to multimedia environment 102 of FIG. 1, as will be appreciated by persons skilled in the relevant art(s) based on the teachings contained herein.

In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media system(s) 104. A media system 104 could represent a family room, a kitchen, a backyard, a home theater, a school classroom, a library, a hotel, a hospital, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content, such as content 122.

Each media system 104 may include one or more media device(s) 106 each coupled to one or more display device(s) 108. It is noted that terms such as “coupled,” “connected to,” “attached,” “linked,” “combined” and similar terms may refer to physical, electrical, magnetic, logical, etc., connections, unless otherwise specified herein.

Media device(s) 106 may be a streaming media device, a streaming set-top box (STB), cable and satellite STB, a DVD or BLU-RAY device, an audio/video playback device, a cable box, and/or a digital video recording device, to name just a few examples. Display device(s) 108 may be a monitor, a television (TV), a computer, a computer monitor, a smart phone, a tablet, a wearable (such as a watch or glasses), an appliance, an internet of things (IoT) device, and/or a projector, to name just a few examples. In some embodiments, media device(s) 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device(s) 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system(s) 104 may include a remote control 110. The remote control 110 can be any component, part, apparatus and/or method for controlling the media device(s) 106 and/or display device(s) 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device(s) 106 and/or display device(s) 108 using cellular, Bluetooth, infrared, etc., or any combination thereof. The remote control 110 may include a microphone 112, which is further described below.

The multimedia environment 102 may include a plurality of content server(s) 120 (also called content providers, channels, or sources). Although only one content server 120 is shown in FIG. 1, in practice the multimedia environment 102 may include any number of content server(s) 120. Each content server 120 may be configured to communicate with network 118. Each content server 120 may be configured to communicate with network 118. Content server(s) 120, media device(s) 106, and display device(s) 108 may be collectively referred to as a media system, which may be an extension of media system(s) 104. In some embodiments, a media system may include system server(s) 126 as well.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Content 122 may be the source displayed on display device(s) 108.

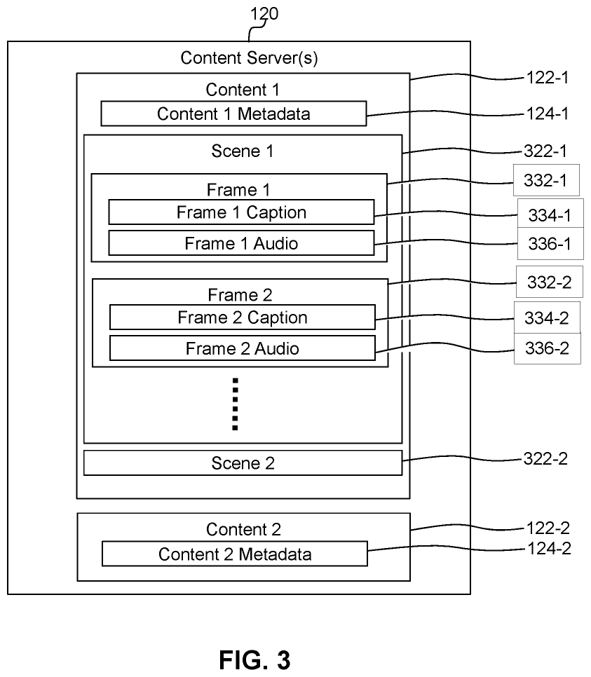

In some embodiments, metadata 124 comprises data about content 122. For example, metadata 124 may include associated or ancillary information indicating or related to categories of the materials in content 122, closed captioning data, audio track, writer, director, producer, composer, artist, actor, summary, chapters, production, history, year, trailers, alternate versions, related content, applications, and/or any other information pertaining or relating to content 122. Metadata 124 may also or alternatively include links to any such information pertaining or relating to the content 122. Metadata 124 may also or alternatively include one or more indexes of content 122, such as but not limited to a trick mode index. In some embodiments, content 122 can include a plurality of content items, and each content item can include a plurality of scenes and frames having corresponding metadata (see FIG. 3).

The multimedia environment 102 may include one or more system server(s) 126. The system server(s) 126 may operate to support the media device(s) 106 from the cloud. It is noted that the structural and functional aspects of the system server(s) 126 may wholly or partially exist in the same or different ones of the system server(s) 126. System server(s) 126 and content server(s) 120 together may be referred to as a media server system. An overall media system may include a media server system and media system(s) 104. In some embodiments, a media system may refer to the overall media system including the media server system and media system(s) 104.

The media device(s) 106 may exist in thousands or millions of media systems 104. Accordingly, the media device(s) 106 may lend themselves to crowdsourcing embodiments and, thus, the system server(s) 126 may include one or more crowdsource server(s) 128.

For example, using information received from the media device(s) 106 in the thousands and millions of media systems 104, the crowdsource server(s) 128 may identify similarities and overlaps between closed captioning requests issued by different user(s) 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie. In some embodiments, crowdsource server(s) 128 can be located at content server(s) 120. In some embodiments, some part of content server(s) 120 functions can be implemented by system server(s) 126 as well.

The system server(s) 126 may also include an audio command processing module 130. As noted above, the remote control 110 may include a microphone 112. The microphone 112 may receive audio data from user(s) 132 (as well as other sources, such as the display device(s) 108). In some embodiments, the media device(s) 106 may be audio responsive, and the audio data may represent verbal commands from the user(s) 132 to control the media device(s) 106 as well as other components in the media system(s) 104, such as the display device(s) 108.

In some embodiments, the audio data received by the microphone 112 in the remote control 110 is transferred to the media device(s) 106, which is then forwarded to the audio command processing module 130 in the system server(s) 126. The audio command processing module 130 may operate to process and analyze the received audio data to recognize the user(s) 132's verbal command. The audio command processing module 130 may then forward the verbal command back to the media device(s) 106 for processing.

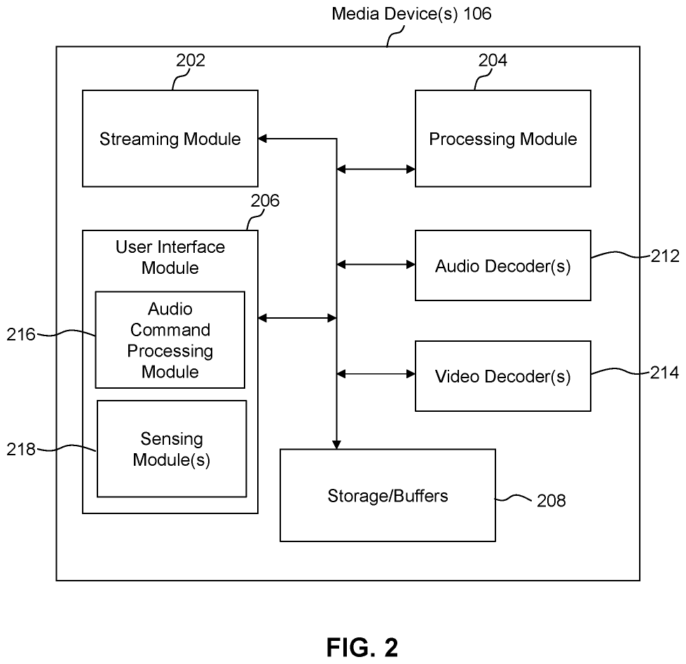

In some embodiments, the audio data may be alternatively or additionally processed and analyzed by an audio command processing module 216 in the media device(s) 106 (see FIG. 2). The media device(s) 106 and the system server(s) 126 may then cooperate to pick one of the verbal commands to process (either the verbal command recognized by the audio command processing module 130 in the system server(s) 126, or the verbal command recognized by the audio command processing module 216 in the media device(s) 106).

FIG. 2 illustrates a block diagram of an example media device(s) 106, according to some embodiments. Media device(s) 106 may include a streaming module 202, processing module 204, storage/buffers 208, and user interface module 206. As described above, user interface module 206 may include audio command processing module 216.

In some embodiments, user interface module 206 may further include one or more sensing module(s) 218. Sensing module(s) 218 can include microphones, cameras, infra-red sensors, touching sensors, to name just some examples. Sensing module(s) 218 can capture sensing signals when user(s) 132 enter within a vicinity of sensing module(s) 218. The sensing signals can include image signals, audio signals, infrared signals, and touching signals, movements, to name just some examples. In some embodiments, sensing module(s) 218 can be integrated into media device(s) 106. In some embodiments, sensing module(s) 218 can be integrated to display device(s) 108, remote control 110, or any devices used by user(s) 132 to interact with media systems 104. In some embodiments, sensing module(s) 218 can be stand-alone modules outside of media device(s) 106, display device(s) 108, remote control 110, and devices used by user(s) 132. Implemented as a stand-alone device, sensing module(s) 218 may be physically located within the vicinity of media device(s) 106 to detect audiences. Media device(s) 106 can receive the sensing signals captured by sensing module(s) 218 and identify one or more user(s) 132 within the vicinity of media device(s) 106 based on identification information in the captured sensing signals.

The media device(s) 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user(s) 132 may interact with the media device(s) 106 via, for example, the remote control 110. For example, the user(s) 132 may use the remote control 110 to interact with the user interface module 206 of the media device(s) 106 to select content, such as a movie, TV show, music, book, application, game, etc. The streaming module 202 of the media device(s) 106 may request the selected content from the content server(s) 120 over the network 118. The content server(s) 120 may transmit the requested content to the streaming module 202. The media device(s) 106 may transmit the received content to the display device(s) 108 for playback to the user(s) 132.

In streaming embodiments, the streaming module 202 may transmit the content to the display device(s) 108 in real time or near real time as it receives such content from the content server(s) 120. In non-streaming embodiments, the media device(s) 106 may store the content received from content server(s) 120 in storage/buffers 208 for later playback on display device(s) 108.

FIG. 3 illustrates a block diagram of content server(s) 120 having corresponding captioning data and audio for each frame of content items, according to some embodiments. As shown in FIG. 3, content server(s) 120 can include a plurality of content items, such as content 122-1 and content 122-2. Content 122-2 can have a similar structure as content 122-1. Though FIG. 3 illustrates two content items on content server(s) 120, content server(s) 120 can include more than two content items having a similar structure as content 122-1. The discussion of elements of content 122-1 applies to content 122-2, unless mentioned otherwise. And like reference numerals generally indicate identical, functionally similar, and/or structurally similar elements.

In some embodiments, as shown in FIG. 3, content 122-1 can include content metadata 124-1. Similarly, content 122-1 can include content metadata 124-2. In some embodiments, content 122-1 can include a plurality of scenes, such as scene 322-1 and scene 322-2. Scene 322-2 can have a similar structure as scene 322-1. In some embodiments, each scene can include a plurality of frames. As an example, scene 322-1 can include frame 332-1 and frame 332-2. Frame 332-2 can have a similar structure as frame 332-1. Frame 332-1 can further include frame caption 334-1 and frame audio 336-1 associated with frame 332-1. In some embodiments, frame caption 334-1 and frame audio 336-2 can correspond to each other based on their timestamps in content 122-1. Similarly, frame 332-2 can further include frame caption 334-2 and frame audio 336-2.

In some embodiments, content metadata 124-1 and 124-2 may include associated or ancillary information similar to metadata 124 as described above. In some embodiments, the associated and ancillary information can be generated by the content creators or by content server(s) 120. In some embodiments, content metadata 124-1 and 124-2 may include color contrast, brightness, histogram of color spectrum, a number of objects, a trajectory of objects, people, places, actions, captioning data and corresponding audio track, genre of content, keywords, a description, and reviews of content 122-1 and 122-2. Frame captions 334-1 and 334-2 can include closed captioning data for dialogues in frames 332-1 and 332-2. Frame audios 336-1 and 336-2 can include audio tracks for dialogues in frames 332-1 and 332-2. In some embodiments, frame caption 334-1 and frame audio 336-1 can correspond to each based on timestamp of the dialogues in frame 332-1. Similarly, frame caption 334-2 and frame audio 336-2 can correspond to each based on timestamp of the dialogues in frame 332-2.

### Customized Audio Filtering of a Content

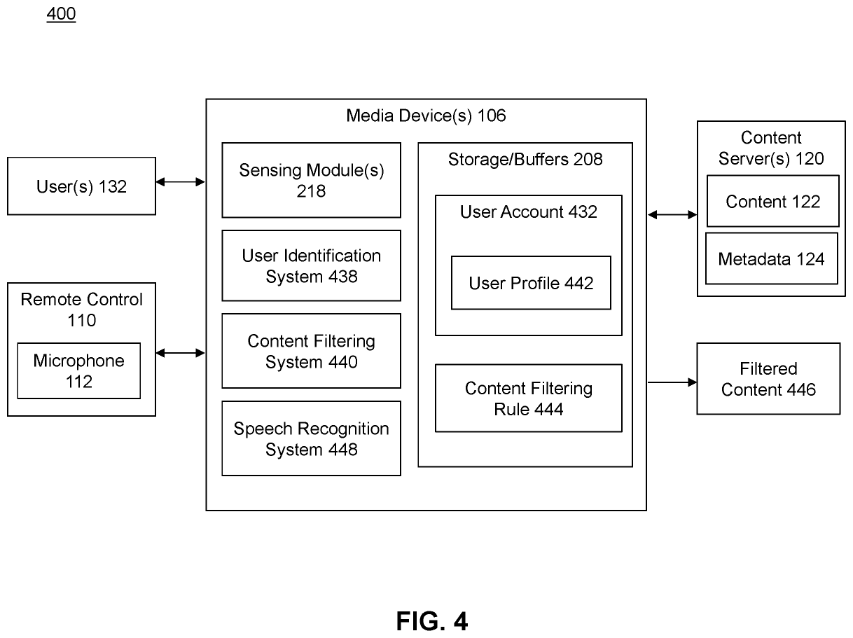

FIG. 4 illustrates a block diagram of a system 400 for customized audio filtering of content on media device(s) 106 for user(s) 132, according to some embodiments. System 400 can receive a filtering instruction from user(s) 132, filter content 122 from content server(s) 120 with media device(s) 106 based on the filtering instruction, and output filtered content 446 to users 132. In some embodiments, system 400 can further include display device(s) 108, communication device 114, network 118, and/or system server(s) 126 as shown in FIG. 1. Media device(s) 106 can further include sensing module(s) 218, user identification system 438, content filtering system 440, and storage/buffers 208. Storage/buffers 208 can further include user account 432 having user profile 442 and content filtering rule 444.

In some embodiments, one or more user(s) 132 can have corresponding user account 432 stored in storage/buffers 208 as shown in FIG. 4. For example, user(s) 132 can be members of a household and user account 432 can include user profile 442 for user(s) 132. In some embodiments, user profile 442 can include respective user preferences for each member of the household associated with user account 432. User profile 442 can be related to and store information about user settings of media systems 104 and customized filtering content for user(s) 132. The filtering content can include text, audio, and/or audio fingerprint of words or audio provided by user(s) 132. For example, user profile 442 can include text, audio, and audio fingerprint for user-defined inappropriate words. In some embodiments, the audio fingerprint can include a large number of parameters to characterize and identify audio of a word or other audio. Though the filtering content of an inappropriate word is described with regard to FIG. 4, the filtering content can include a phrase, a sentence, or other parts of audio content. The following discussion will focus on words defined as inappropriate by a user but is not limited to only inappropriate words, and may include any words or audio provided by a user. In some embodiments, content filtering system 440 may use multiple examples of the audio of an inappropriate word (or words) for audio fingerprint identification. In some embodiments, the words provided by user(s) 132 may be used as customized filtering content, which can be filtered out from content 122 to be presented on media device(s) 106. In some embodiments, the filtering content can be customized for identified user(s) 132 that are detected within a vicinity of media device(s) 106. In some embodiments, the customized filtering content for a parent can be different from the customized filtering content for a child. Additionally, user profile 442 can include identification information of user(s) 132, such as images and/or audio recordings of user(s) 132 for user identification.

In some embodiments, content filtering rule 444 can include a list of predefined filtering contents to be applied to content 122. The predefined list of filtering contents can be a generic filtering setting for media device(s) 106. The predefined list of filtering contents can include text, audio, and/or audio fingerprint of inappropriate words in multimedia environment 102. In some embodiments, a filtering content can be applied not just to one user or members of a household but can also be location-based to a particular environment, such as a school, a hotel, an airport, or a hospital. In some embodiments, the predefined list of filtering contents can be different for different multimedia environment 102. For example, the predefined list of filtering contents for a hospital can be different from the predefined list of filtering contents for a school. In some embodiments, media device(s) 106 for multimedia environment 102 can be customized with different predefined lists of filtering contents.

In some embodiments, user(s) 132 may not have user account 432 set up in storage/buffers 208. For example, user(s) 132 may be guests of one or more members of the household. User(s) 132 may be guest children or adults and may have no corresponding user account 432. Corresponding content filtering rule 444 can be determined for identified user(s) 132. User(s) 132 within a vicinity of media device(s) 106 can be detected by sensing module(s) 218 and identified by user identification system 438.

Referring to FIG. 4, user identification system 438 can identify audiences within a vicinity of media device(s) 106, such as user(s) 132. In some embodiments, user identification system 438 can identify user(s) 132 as adults, children, members of household, guests, or other categories. The identification information can include image signals, audio signals, infrared signals, touching signals, movements, and/or other information of user(s) 132 captured by sensing module(s) 218. In some embodiments, user identification system 438 can include a machine-learning model trained with the image signals, audio signals, infrared signals, touching signals, movements, and/or other information in user profile 442. In some embodiments, the machine-learning model can be trained with one or more databases having image signals, audio signals, infrared signals, touching signals, movements, and/or other information. The machine-learning model can identify the detected image signals, audio signals, infrared signals, touching signals, movements, and/or other information captured by sensing module(s) 218 and associate the captured information with corresponding categories of user(s) 132. As a result, user identification system 438 can identify user(s) 132 based on the captured information using the machine-learning model.

In some embodiments, if user(s) 132 have corresponding user profile 442 with stored image, audio, infrared, movement, and other information, user identification system 438 can identify user(s) 132 based on the stored information in user profile 442. With identified user profile 442, the filtering content associated with user(s) 132 can be determined. In some embodiments, if user(s) 132 have no user account 432 or user account 432 has no image, audio, infrared, movement, or other information for user(s) 132, user identification system 438 can compare the captured information with corresponding information in the one or more databases and determine the category for user(s) 132 using the machine-learning model. In some embodiments, user profile 442 can include different content filtering rules associated with user(s) 132 for different times of a day. For example, user profile 442 can include a stringent content filtering rule for daytime and prime time and a relaxed content filtering rule for late nighttime. In some embodiments, the stringent content filtering rule can include more filtering content, for example, words, phrases, and sentences inappropriate for children, than the relaxed content filtering rule. Accordingly, content filtering system 440 can apply different content filtering rules at different times of a day.

In some embodiments, if a group of people is detected in the vicinity of media device(s) 106 by sensing module(s) 218, content filtering system 440 can apply content filtering rule 444 having the highest priority associated with a person in the detected group. For example, content filtering rule 444 for a child can have a higher priority than content filtering rule 444 for an adult. As another example, content filtering rule 444 for a household member can have a higher priority than content filtering rule 444 for a guest.

In some embodiments, content filtering system 440 can automatically identify the filtering content in content 122 to be presented by a media device and filter out the filtering content in the captioning data and audio track of content 122. In some embodiments, content filtering system 440 can receive a filtering instruction from user(s) 132 and filter out the filtering content based on the filtering instruction. In some embodiments, the filtering instruction can be transmitted in response to a selection of a filtering content from a predefined list of filtering contents. Content filtering system 440 can identify the selected filtering content in the captioning data and audio track of content 122 and filter out the selected filtering content from content 122. In some embodiments, content filtering system 440 can identify the selected filtering content in the captioning data based on a text search and in the audio track based on an audio fingerprint of the selected filtering content.

In some embodiments, the filtering instruction can include a text input. For example, user(s) 132 may input the text of one or more words using remote control 110 for audio filtering. In some embodiments, the one or more words may not be in the predefined list of filtering contents in content filtering rule 444. Content filtering system 440 can identify the filtering content in the captioning data of content 122 based on a search using the text input. Content filtering system 440 can identify the filtering content in the audio track of content 122 based on timestamp correspondence between the captioning data and the audio track. In some embodiments, content filtering system 440 can include a machine-learning model to identify and match the filtering content in the captioning data and the audio track. In some embodiments, the machine-learning model can be included in media device(s) 106. In some embodiments, the machine-learning model can be included in system server(s) 126.

In some embodiments, the filtering instruction can include a voice input. For example, user(s) 132 may speak one or more words to remote control 110 for audio filtering. In some embodiments, content filtering system 440 may determine an audio fingerprint of the voice input using the machine-learning model. In some embodiments, the one or more words may not be in the predefined list of filtering contents in content filtering rule 444. In some embodiments, content filtering system 440 can identify the filtering content in the audio track of content 122 based on the audio fingerprint of the voice input. In some embodiments, content filtering system 440 may use multiple examples of the voice input to train the machine-learning model for audio fingerprint determination and identification. In some embodiments, content filtering system 440 can determine the audio fingerprint of a word, a phrase, or a sentence and add the audio fingerprint to the predefined list of filtering contents. In some embodiments, the added audio fingerprint can be uploaded to a database for a generic setting of additional media device(s) 106. In some embodiments, content filtering system 440 can further identify the filtering content in the captioning data of content 122 based on timestamp correspondence between the captioning data and the audio track.

In some embodiments, speech recognition system 448 can translate the voice input and determine a text corresponding to the voice input. In some embodiments, content filtering system 440 can receive the determined text for the voice input from speech recognition system 448. In some embodiments, content filtering system 440 can identify the filtering content in the captioning data of content 122 based on a search using the determined text. In some embodiments, speech recognition system 448 can be included in media device(s) 106 or media systems 104 to recognize the voice input, such as audio command processing module 216. In some embodiments, speech recognition system 448 can be included in system server(s) 126, such as audio command processing module 130, to communicate with media device(s) 106. In some embodiments, speech recognition system 448 can be a third party system communicating with media device(s) 106.

In some embodiments, upon receiving a voice input, speech recognition system 448 can recognize the voice input and determine a text corresponding to the voice input. In some embodiments, content filtering system 440 can identify the filtering content in the captioning data of content 122 based on a search using the determined text. In some embodiments, content filtering system 440 can identify the filtering content in the audio track of content 122 based on timestamp correspondence between the captioning data and the audio track.

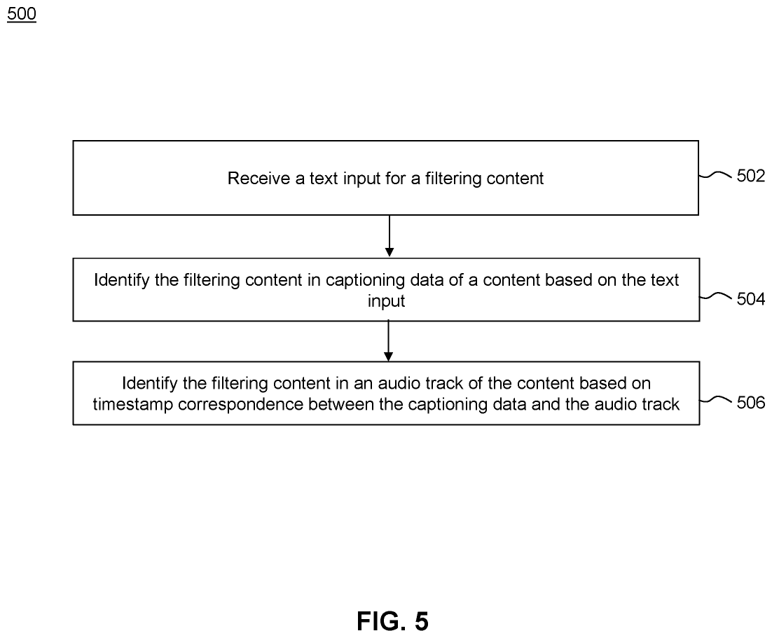

FIG. 5 is a flowchart illustrating a method 500 for identifying filtering content in an audio track of a content based on a text input, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to FIG. 4. However, method 500 is not limited to that example embodiment. FIGS. 1-3 illustrate more details of method 500 during the process of identifying a filtering content in an audio track of a content.

Referring to FIG. 5, in step 502, a text input is received for a filtering content. For example, as shown in FIG. 4, user(s) 132 can use remote control 110 to type a text input for a filtering content and media device(s) 106 can receive the text input from remote control 110. In some embodiments, the text input can be a word, a phrase, or a sentence. User(s) 132 may type a word, a phrase, or a sentence that user(s) 132 may not want to see in the captioning data and/or hear in the audio track of a content. The text input can be used to filter out the text in the captioning data and the selected audio in the audio track. In some embodiments, the text input received by remote control 110 can be sent to content filtering system 440. Content filtering system 440 can use the text input as the filtering content. In some embodiments, the text input can be stored in user profile 442 of user account 432 associated with user(s) 132.

In step 504, the filtering content is identified in captioning data of a content based on the text input. For example, as shown in FIG. 4, the filtering content can be identified in captioning data of content 122 based on the text input from user(s) 132. In some embodiments, content filtering system 440 can identify the filtering content by a text search in the captioning data of content 122 for the received text input.

In step 506, the filtering content is identified in an audio track of the content based on timestamp correspondence between the captioning data and the audio track. For example, as shown in FIG. 4, the filtering content can be identified in an audio track of content 122 based on timestamp correspondence between the captioning data and the audio track. In some embodiments, the captioning data and the audio track of each frame of content 122 are synchronized to each other based on timestamp. For example, as shown in FIG. 3, frame captions 334-1 and 334-2 can correspond to frame audios 336-1 and 336-2 based on timestamp, respectively. In some embodiments, content filtering system 440 can identify the filtering content in the audio track of content 122 based on the timestamp correspondence with the captioning data.

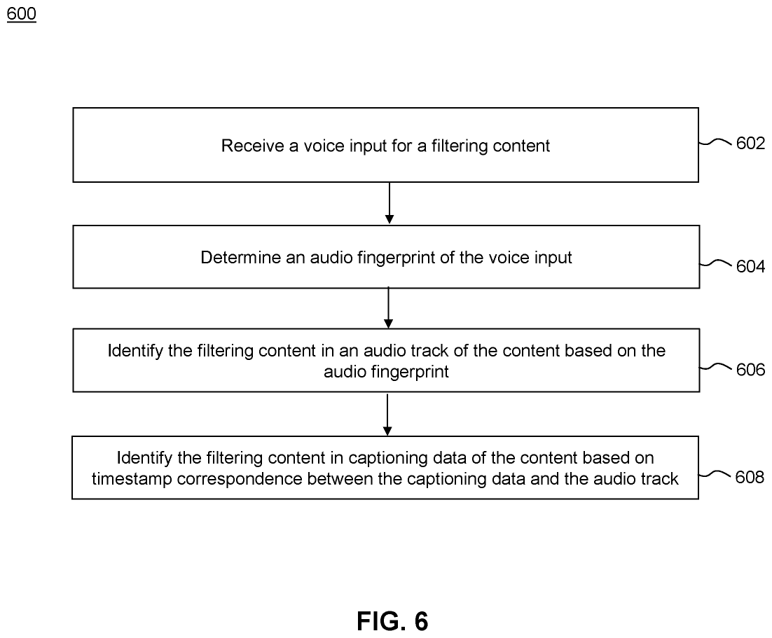

FIG. 6 is a flowchart illustrating a method 600 for identifying filtering content in captioning data and an audio track of content based on an audio fingerprint of a voice input, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art. Method 600 shall be described with reference to FIG. 4. However, method 600 is not limited to that example embodiment. FIGS. 1-3 illustrate more details of method 600 during the process of determining the category of the audience.

Referring to FIG. 6, in step 602, voice input is received for filtering content. For example, as shown in FIG. 4, user(s) 132 can use microphone 112 on remote control 110 to give voice input for filtering content and media device(s) 106 can receive the voice input from remote control 110. In some embodiments, the voice input can be a word, a phrase, or a sentence. User(s) 132 may say a word, a phrase, or a sentence that user(s) 132 may not want to hear in the audio track of a content. The voice input can be used to filter out the selected audio matching the voice input from the audio track. In some embodiments, the voice input received by remote control 110 can be sent to content filtering system 440. Content filtering system 440 can use the voice input as the filtering content. In some embodiments, the voice input can be stored in user profile 442 of user account 432 associated with user(s) 132. In some embodiments, user profile 442 may store multiple examples of the voice input for the filtering content.

In step 604, an audio fingerprint of the voice input is determined. For example, as shown in FIG. 4, an audio fingerprint of the voice input can be determined based on the voice input from user(s) 132. In some embodiments, content filtering system 440 can determine the audio fingerprint of the voice input. In some embodiments, content filtering system 440 can include a machine-learning model to determine the audio fingerprint of the voice input. In some embodiments, the audio fingerprint can include a large number of parameters to characterize and identify the voice input. In some embodiments, content filtering system 440 may use multiple examples of the voice input (e.g., provided as crowdsource data by crowdsource server(s) 128) to train the machine-learning model for audio fingerprint determination and identification.

In step 606, the filtering content is identified in an audio track of content based on the audio fingerprint. For example, as shown in FIG. 4, the filtering content can be identified in an audio track of content 122 based on the audio fingerprint of the voice input. In some embodiments, content filtering system 440 can use the machine-learning model to identify the filtering content in the audio track of content 122 based on the audio fingerprint of the received voice input.

In step 608, the filtering content is identified in captioning data of the content based on timestamp correspondence between the captioning data and the audio track. For example, as shown in FIG. 4, the filtering content can be identified in captioning data of content 122 based on timestamp correspondence between the captioning data and the audio track. In some embodiments, the captioning data and the audio track of each frame of content 122 can correspond to each other based on timestamp. For example, as shown in FIG. 3, frame audios 336-1 and 336-2 can correspond to frame captions 334-1 and 334-2 based on timestamp, respectively. In some embodiments, content filtering system 440 can identify the filtering content in the captioning data of content 122 based on the timestamp correspondence.

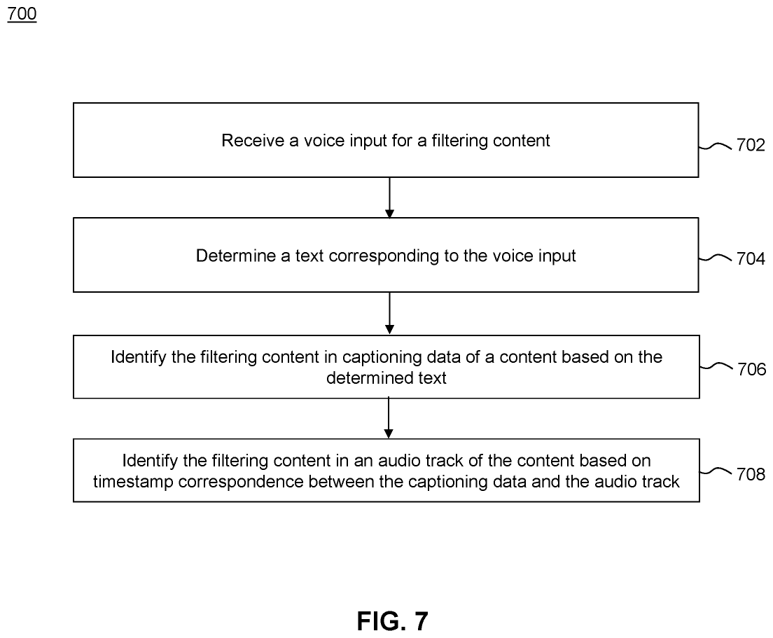

FIG. 7 is a flowchart illustrating a method 700 for identifying filtering content in captioning data and an audio track of a content according to a determined text of a voice input, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art. Method 700 shall be described with reference to FIG. 4. However, method 700 is not limited to that example embodiment. FIGS. 1-3 illustrate more details of method 700 during the process of determining the category of the audience.

Referring to FIG. 7, in step 702, a voice input is received for identifying filtering content. For example, as shown in FIG. 4, user(s) 132 can use microphone 112 on remote control 110 to give a voice input for identifying filtering content and media device(s) 106 can receive the voice input from remote control 110. In some embodiments, the voice input can be a word, a phrase, or a sentence. User(s) 132 may say a word, a phrase, or a sentence that user(s) 132 may not want to hear in the audio track of a content. The voice input can be used to filter out the selected audio matching the voice input from the audio track. In some embodiments, the voice input received by remote control 110 can be sent to content filtering system 440. Content filtering system 440 can use the voice input as the filtering content. In some embodiments, the voice input can be stored in user profile 442 of user account 432 associated with user(s) 132.

In step 704, a text is determined corresponding to the voice input. For example, as shown in FIG. 4, speech recognition system 448 may determine a text corresponding to the voice input received from user(s) 132. In some embodiments, speech recognition system 448 may determine the corresponding text for a word, a phrase, or a sentence of the voice input. In some embodiments, the determined text can be stored in user profile 442 of user account 432 associated with user(s) 132. In some embodiments, content filtering system 440 can use the determine text as the filtering content.

In step 706, the filtering content can be identified in captioning data of a content based on the determined text. For example, as shown in FIG. 4, the filtering content can be identified in captioning data of content 122 based on the determined text from user(s) 132. In some embodiments, content filtering system 440 can identify the filtering content by a text search in the captioning data of content 122 for the determined text.

In step 708, the filtering content can be identified in an audio track of the content based on timestamp correspondence between the captioning data and the audio track. For example, as shown in FIG. 4, the filtering content can be identified in an audio track of content 122 based on timestamp correspondence between the captioning data and the audio track. In some embodiments, the captioning data and the audio track of each frame of content 122 can correspond to each other based on timestamp. For example, as shown in FIG. 3, frame captions 334-1 and 334-2 can correspond to frame audios 336-1 and 336-2 based on timestamp, respectively. In some embodiments, content filtering system 440 can identify the filtering content in the audio track of content 122 based on the timestamp correspondence with the captioning data.

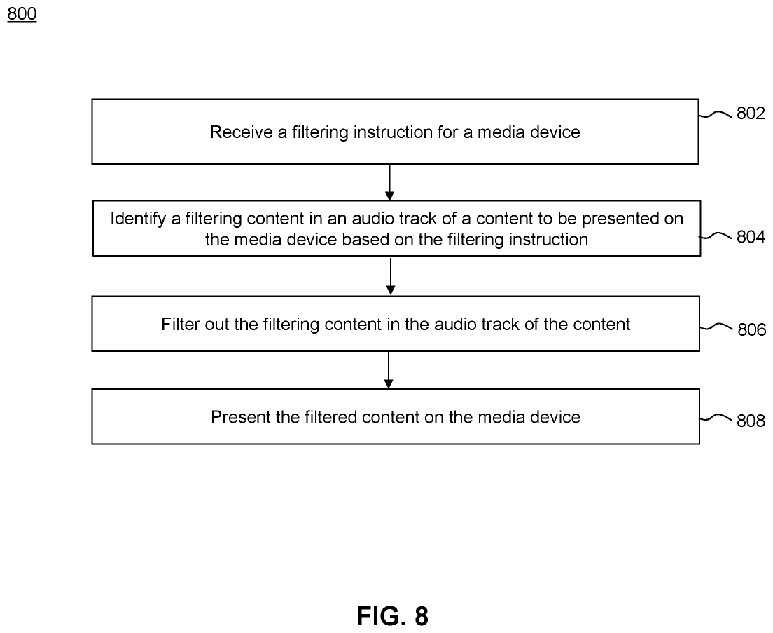

FIG. 8 is a flowchart illustrating a method 800 for automatically filtering out filtering content in an audio track of content to be presented on a media device based on a filtering instruction, according to some embodiments. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art. Method 800 shall be described with reference to FIG. 4. However, method 800 is not limited to that example embodiment. FIGS. 1-3 illustrate more details of method 800 during the process of automatic parental controls based on audiences.

Referring to FIG. 8, in step 802, a filtering instruction is received for a media device. For example, as shown in FIG. 4, user(s) 132 can use remote control 110 to send a filtering instruction for media device(s) 106. In some embodiments, the filtering instruction can include a text input. In some embodiments, the filtering instruction can include a voice input. In some embodiments, the filtering instruction can include a selection of filtering content from a predefined list of filtering contents. The predefined list of filtering content can include text, audio, and audio fingerprint for a word, a phrase, or a sentence that are inappropriate for user(s) 132. In some embodiments, content filtering rule 444 can include the predefined list of filtering contents. For example, content filtering rule 444 can include a predefined list of inappropriate words, phrases, and sentences. In some embodiments, the filtering instruction can be sent to content filtering system 440 and content filtering system 440 can use the filtering instruction to filter content 122.

In step 804, filtering content is identified in an audio track of a content to be presented on the media device based on the filtering instruction. For example, as shown in FIG. 4, content filtering system 440 can identify the filtering content in an audio track of content 122 to be presented on media device(s) 106 based on the received filtering instruction. In some embodiments, the filtering instruction can include a text input. Content filtering system 440 can identify the filtering content in the audio track of content 122 as described in method 500. In some embodiments, the filtering instruction can include a voice input. Content filtering system 440 can identify the filtering content in the audio track of content 122 as described in method 600 or method 700. In some embodiments, the filtering instruction can include a selection of a filtering content from a predefined list of filtering contents. If the predefined list includes a text of the filtering content, content filtering system 440 can identify the filtering content in the audio track of content 122 as described in method 500. If the predefined list includes an audio fingerprint of the filtering content, content filtering system 440 can identify the filtering content in the audio track of content 122 as described in method 600. If the predefined list includes an audio of the filtering content, content filtering system 440 can identify the filtering content in the audio track of content 122 as described in method 600 or method 700.

In step 806, the filtering content is filtered out in the audio track of the content. For example, as shown in FIG. 4, content filtering system 440 can filter out the filtering content in content 122 and generate filtered content 446 for user(s) 132. In some embodiments, the filtering content can be bleeped out or muted in the audio track of content 122 to prevent media device(s) 106 from outputting the filtering content while playing content 122. In some embodiments, the filtering content can be replaced with an appropriate description of the filtering content. The replaced appropriate description can blank out the filtering content in content 122 and provide context of the filtering content to keep filtered content 446 understandable to user(s) 132. In some embodiments, in multi-channel audio tracks, the center channel may include voices and other channels may include music and other audios. The filtering content can be bleeped out or muted in the center channel for voices. In some embodiments, in stereo audio tracks, the voices, music, and other audios may be mixed in both left and right audio channels. The filtering content can be bleeped out or muted in both left and right audio channels for voices. In some embodiments, the filtering content in the captioning data of content 122 can be replaced with asterisks to prevent media device(s) 106 from displaying the filtering content in the captioning data when playing content 122.

In some embodiments, the filtering content can be filtered out in real time during presentation of content 122. Media device(s) 106 may buffer a portion of content 122 in storage/buffers 208 during presentation of content 122. Content filtering system 400 can filter out the filtering content in the buffered portion of content 122 prior to the presentation of the buffered portion. In some embodiments, the filtering content can be filtered out offline for content 122. The captioning data and the audio track of content 122 can be filtered before delivered to media device(s) 106.

In step 808, the filtered content is presented on the media device. For example, as shown in FIG. 4, the filtered content can be presented on media device(s) 106. In some embodiments, the filtered content can be presented by media device(s) 106 on display device(s) 108. As a result, media device(s) 106 can present content 122 filtered by content filtering system 440 and can display customized filtering content to user(s) 132.

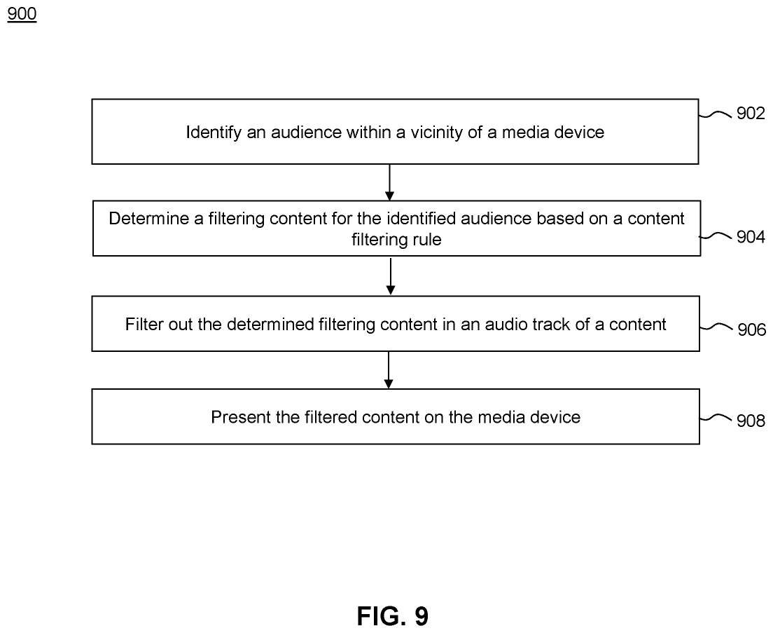

FIG. 9 is a flowchart illustrating a method 900 for automatically filtering out filtering content in an audio track of content to be presented on a media device based on an identified audience, according to some embodiments. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art. Method 900 shall be described with reference to FIG. 4. However, method 900 is not limited to that example embodiment. FIGS. 1-3 illustrate more details of method 900 during the process of automatic parental controls based on identified audiences.

Referring to FIG. 9, in step 902, an audience is identified within a vicinity of a media device. For example, as shown in FIG. 4, user identification system 438 can identify an audience within a vicinity of media device(s) 106. In some embodiments, sensing module(s) 218 can capture image signals, audio signals, infrared signals, touching signals, movements, and/or other information of user(s) 132 within a vicinity of media device(s) 106. User identification system 438 can use the captioning data information to identify user(s) 132 as an adult, a child, a member of household, a guest, or other categories. In some embodiments, the vicinity can be a spatial limit, such as fifteen feet from media device(s) 106 or within the room of media device(s) 106.

In step 904, filtering content is determined for the identified audience based on a content filtering rule. For example, as shown in FIG. 4, content filtering system 440 can determined a filtering content for the identified audience based on content filtering rule 444. In some embodiments, content filtering system 440 can identify the filtering content in the predefined list of filtering contents in content filtering rule 444 based on the identified category for user(s) 132. For example, if user(s) 132 is identified as a child, the filtering content may include additional words, phrases, and sentences than the filtering content for an adult.

In step 906, the determined filtering content is filtered out of an audio track of content. For example, as shown in FIG. 4, content filtering system 440 can filter out the determined filtering content in content 122 and generate filtered content 446 for user(s) 132. In some embodiments, the filtering content can be bleeped out or muted in the audio track of content 122 to prevent media device(s) 106 from outputting the filtering content while playing content 122. In some embodiments, the filtering content can be replaced with an appropriate description of the filtering content. In some embodiments, the filtering content in the captioning data of content 122 can be replaced with asterisks to prevent media device(s) 106 from displaying the determined filtering content in the captioning data when playing content 122.

In step 908, the filtered content is presented on the media device. For example, as shown in FIG. 4, the filtered content can be presented on media device(s) 106. In some embodiments, the filtered content can be presented by media device(s) 106 on display device(s) 108. As a result, media device(s) 106 can present content 122 filtered by content filtering system 440 and can display customized filtering content to user(s) 132.

### Example Computer System

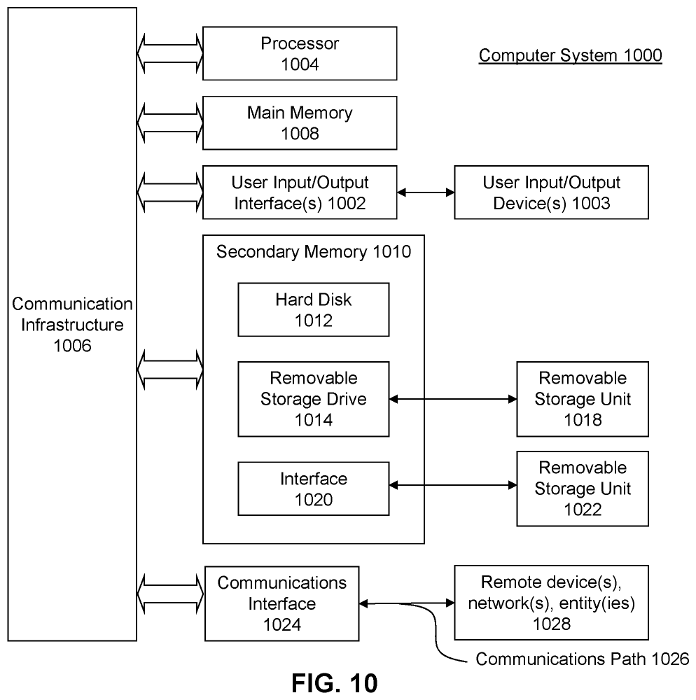

Various embodiments may be implemented, for example, using one or more well-known computer systems, such as computer system 1000 shown in FIG. 10. For example, the media device(s) 106 may be implemented using combinations or sub-combinations of computer system 1000. Also, or alternatively, one or more computer systems 1000 may be used, for example, to implement any of the embodiments discussed herein, as well as combinations and sub-combinations thereof.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000 or processor(s) 1004), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a storage module; and
at least one processor each coupled to the storage module and configured to:
receive a filtering instruction for a media device;
identify, based on the filtering instruction, a filtering content in an audio track of a content to be presented on the media device;
filter out the filtering content in the audio track of the content; and
present the filtered content on the media device.

2. The system of claim 1, wherein to receive the filtering instruction for the media device, the at least one processor is configured to receive a selection of the filtering content from a predefined list of filtering contents.

3. The system of claim 1, wherein to identify the filtering content in the audio track of the content, the at least one processor is configured to determine an audio fingerprint of the filtering content and identify the audio fingerprint in the audio track of the content.

4. The system of claim 1, wherein the filtering instruction includes a text input and the at least one processor is further configured to:
identify the filtering content in captioning data of the content based on the text input; and
identify the filtering content in the audio track of the content based on timestamp correspondence between the captioning data and the audio track.

5. The system of claim 1, wherein the filtering instruction includes a voice input, the at least one processor is configured to:
determine an audio fingerprint of the voice input; and
identify the filtering content in the audio track of the content based on the audio fingerprint.

6. The system of claim 5, wherein the at least one processor is further configured to:
identify the filtering content in captioning data of the content based on timestamp correspondence between the captioning data and the audio track; and
filter out the filtering content in the captioning data of the content.

7. The system of claim 5, wherein the at least one processor is further configured to:
determine a text corresponding to the voice input;
identify the filtering content in captioning data of the content based on the determined text; and
filter out the filtering content in the captioning data of the content.

8. The system of claim 1, wherein the filtering instruction includes a voice input, the at least one processor configured to:
determine a text corresponding to the voice input;
identify the filtering content in captioning data of the content based on the determined text; and
identify the filtering content in the audio track of the content based on timestamp correspondence between the captioning data and the audio track.

9. The system of claim 1, wherein the at least one processor is further configured to:
identify an audience within a vicinity of the media device; and
determine the filtering content for the identified audience based on a content filtering rule.

10. The system of claim 1, wherein the filtering content comprises a word, a phrase, or a sentence.

11. A computer-implemented method, comprising:
receiving a filtering instruction for a media device;
identifying, based on the filtering instruction, a filtering content in an audio track of a content to be presented on the media device;
filtering out the filtering content in the audio track of the content; and
presenting the filtered content on the media device.

12. The computer-implemented method of claim 11, wherein receiving the filtering instruction for the media device comprises receiving a selection of the filtering content from a predefined list of filtering contents.

13. The computer-implemented method of claim 11, wherein identifying the filtering content in the audio track of the content comprises:
determining an audio fingerprint of the filtering content; and
identifying the audio fingerprint in the audio track of the content.

14. The computer-implemented method of claim 11, wherein the filtering instruction includes a text input, the computer-implemented method further comprising:
identifying the filtering content in captioning data of the content based on the text input; and
identifying the filtering content in the audio track of the content based on timestamp correspondence between the captioning data and the audio track.

15. The computer-implemented method of claim 11, wherein the filtering instruction includes a voice input, the computer-implemented method further comprising:
determining an audio fingerprint of the voice input; and
identifying the filtering content in the audio track of the content based on the audio fingerprint.

16. The computer-implemented method of claim 11, wherein the filtering instruction includes a voice input, the computer-implemented method further comprising:
determining a text corresponding to the voice input;
identifying the filtering content in captioning data of the content based on the determined text; and
identifying the filtering content in the audio track of the content based on timestamp correspondence between the captioning data and the audio track.

17. A non-transitory computer-readable medium having instructions stored thereon that, when executed by at least one computing device, cause the at least one computing device to perform operations comprising:
receiving a filtering instruction for a media device;
identifying, based on the filtering instruction, a filtering content in an audio track of a content to be presented on the media device;
filtering out the filtering content in the audio track of the content; and
presenting the filtered content on the media device.

18. The non-transitory computer-readable medium of claim 17, wherein the filtering instruction includes a text input, the operations further comprising:
identifying the filtering content in captioning data of the content based on the text input; and
identifying the filtering content in the audio track of the content based on timestamp correspondence between the captioning data and the audio track.

19. The non-transitory computer-readable medium of claim 17, wherein the filtering instruction includes a voice input, the operations further comprising:
determining an audio fingerprint of the voice input; and
identifying the filtering content in the audio track of the content based on the audio fingerprint.

20. The non-transitory computer-readable medium of claim 17, wherein the filtering instruction includes a voice input, the operations further comprising:
determining a text corresponding to the voice input;
identifying the filtering content in captioning data of the content based on the determined text; and
identifying the filtering content in the audio track of the content based on timestamp correspondence between the captioning data and the audio track.
